(19) United States
(12) Patent Application Publication
(10) Pub. No.: US 2023/0098043 A1
(43) Pub. Date: Mar. 30, 2023

(54) CONNECTION SYSTEMS

(71) Applicant: Meta Platforms Technologies, LLC, Menlo Park, CA (US)

(72) Inventors: Lei Yin, Santa Clara, CA (US); Dennis Do, Cupertino, CA (US); Riccardo DeSalvo, Pasadena, CA (US); Nicole Kathleen Virdone, Pasadena, CA (US); Sabrina Monique Sandoval, edondo Beach, CA (US); Aaron Bobuk, Bellevue, WA (US); Fletcher Nelson, Maple Valley, WA (US); Sam Sarmast, Redmond, WA (US)

(21) Appl. No.: 18/057,502

(22) Filed: Nov. 21, 2022

Related U.S. Application Data
(60) Provisional application No. 63/281,925, filed on Nov. 22, 2021.
(60) Provisional application No. 63/331,599, filed on Apr. 15, 2022.
(60) Provisional application No. 63/381,647, filed on Oct. 31, 2022.
(60) Provisional application No. 63/424,402, filed on Nov. 10, 2022.
(60) Provisional application No. 63/424,403, filed on Nov. 10, 2022.

(51) Int. Cl. H01R 13/70; H01R 13/66

(52) U.S. Cl. CPC H01R 13/70; H01R 13/6683

(57) ABSTRACT

The disclosed computer-implemented method may include one or more multi-purpose connectors, one or more microfluidic devices, systems and methods for securing board-to-board connections, one or more embedded micro-coaxial wires in one or more rigid substrates, one or more miniature, micro-coaxial-to-board interconnect frogboards, and/or one or more artificial reality applications thereof. Various other methods, systems, and computer-readable media are also disclosed.

### CROSS REFERENCE TO RELATED APPLICATION

This application claims the benefit of U.S. Provisional Application No. 63/281,925, filed 22 Nov. 2021, U.S. Provisional Application No. 63/331,599, filed 15 Apr. 2022, U.S. Provisional Application No. 63/381,647, Filed 31 Oct. 2022, U.S. Provisional Application No. 63/424,402, filed 10 Nov. 2022, and U.S. Provisional Application No. 63/424,403, filed 10 Nov. 2022, the disclosures of each of which are incorporated, in their entirety, by this reference.

### BRIEF DESCRIPTION OF THE DRAWINGS

FIG. 1 is a flow diagram of an exemplary method of operation for a multi-purpose connector.

FIG. 2 is a block diagram of an exemplary computing device that includes a multi-purpose connector.

FIG. 3 is a block diagram of an exemplary computing device that includes a multi-purpose connector with a USB communication protocol.

FIG. 4 is a block diagram of an exemplary computing device that includes a multi-purpose connector that incorporates a load switch that is responsive to a Hall-effect sensor.

FIG. 5 is a block diagram illustrating an example in which the computing device of FIG. 4 is connected to a USB charger.

FIG. 6 is a block diagram illustrating an example in which the computing device of FIG. 4 is connected to a smart accessory.

FIG. 7 is a block diagram illustrating an example in which the computing device of FIG. 4 is connected to a smart accessory that includes a USB charger.

FIG. 8A is a side view of example terminals that may be used by a multi-purpose connector.

FIG. 8B is a bottom-up view of the example terminals illustrated in FIG. 8B.

FIG. 9 is an illustration of an example fluidic control system that may be used in connection with embodiments of this disclosure.

FIG. 10A is a plan view of a stator substrate of a microfluidic device, according to at least one embodiment of the present disclosure.

FIG. 10B is a plan view of a rotor substrate of a microfluidic device, according to at least one embodiment of the present disclosure.

FIG. 10C is an exploded perspective view of a microfluidic device including the stator substrate of FIG. 10A and the rotor of FIG. 10B.

FIG. 11A is a plan view of a stator of a microfluidic device, according to at least one additional embodiment of the present disclosure.

FIG. 11B is a plan view of a rotor of a microfluidic device, according to at least one additional embodiment of the present disclosure.

FIG. 11C is an exploded perspective view of a microfluidic device including the stator of FIG. 11A and the rotor of FIG. 11B.

FIG. 12 is a cross-sectional side view of a microfluidic pump, according to at least one embodiment of the present disclosure.

FIG. 13 illustrates a cross sectional view of a first exemplary board-to-board connector that may be used in connection with the embodiments of this disclosure.

FIG. 14 illustrates a perspective view of one of the boards shown in FIG. 13 according to embodiments of this disclosure.

FIG. 15 illustrates a perspective view of an embedded micro-coaxial wire in a rigid substrate according to embodiments of this disclosure.

FIG. 16 illustrates a perspective view of a wire-to-board (WTB) interconnect according to embodiments of this disclosure.

FIG. 17 illustrates a perspective view of a wire-to-board (WTB) interconnect implemented in conjunction with an artificial-reality system according to embodiments of this disclosure.

FIG. 18 is an illustration of example augmented-reality glasses that may be used in connection with embodiments of this disclosure.

FIG. 19 is an illustration of an example virtual-reality headset that may be used in connection with embodiments of this disclosure.

FIG. 20 is an illustration of example haptic devices that may be used in connection with embodiments of this disclosure.

FIG. 21 is an illustration of an example virtual-reality environment according to embodiments of this disclosure.

FIG. 22 is an illustration of an example augmented-reality environment according to embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

### Multi-Purpose Connector

Many of today's computing devices, such as smart watches, are designed to be charged by physically connecting to a power source. For example, a smart watch may include a set of physical connectors (e.g., spring loaded pogo pins) that are dedicated to (and exclusively used for) charging a battery of the smart watch.

However, computing devices (such as smart watches) may also need to power and communicate with other devices, such as smart accessories. Since smart accessories often require low latency, low power, and high-speed data transfer for real time sensor data, file, and/or bulk data exchanges, computing devices may include additional physical connectors dedicated to powering and/or communicating with such smart accessories. However, this requirement for extra connectors (in addition to the connectors required to power or charge the computing device itself) may increase the cost of the computing device and/or prevent an advantageous miniaturization of the computing device.

The present disclosure, in contrast, is generally directed to a multi-purpose connector for a computing device, such as a smart watch, that enables the same connector (or set of connectors) to be used to both charge the computing device and communicate with and power smart accessories. As will be described in greater detail below, this multi-purpose connector may include at least one data terminal and at least one power terminal. In one example, a detector may sense when the multi-purpose connector is connected to a power source and/or a smart accessory. A switch may connect the data terminal to a power management circuit of the computing device in response to detecting a connection to the power source. Alternatively, the switch may connect the data terminal to a physical processor of the computing device in response to detecting a connection to the smart accessory. A roll-call polling mechanism may recognize a connected smart accessory and initiate a connection to a processor of the computing device. As will be explained in greater detail below, this multi-purpose connector may advantageously avoid the need for extra terminals or pins (in addition to the terminals or pins already used for charging the computing device) to power and communicate with smart accessories.

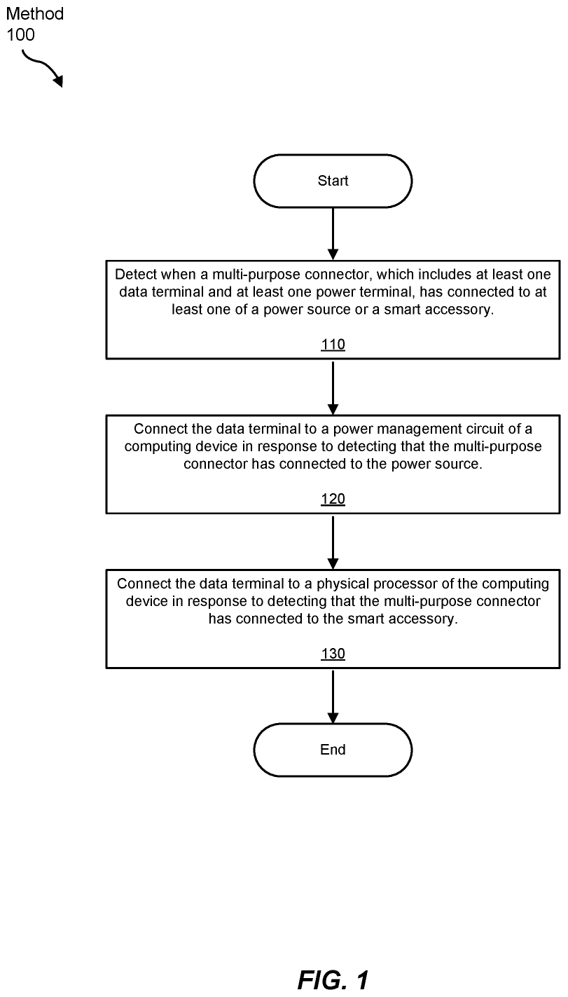

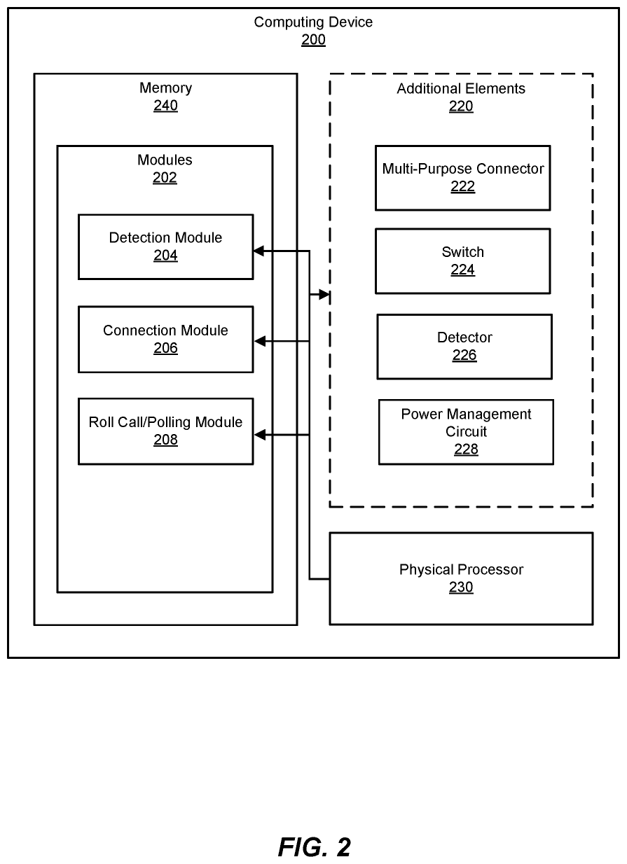

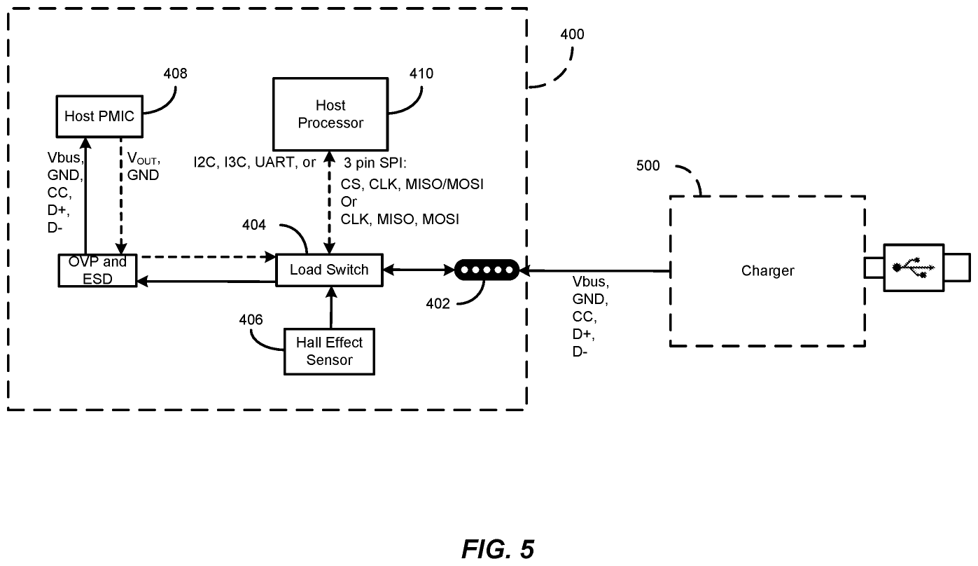

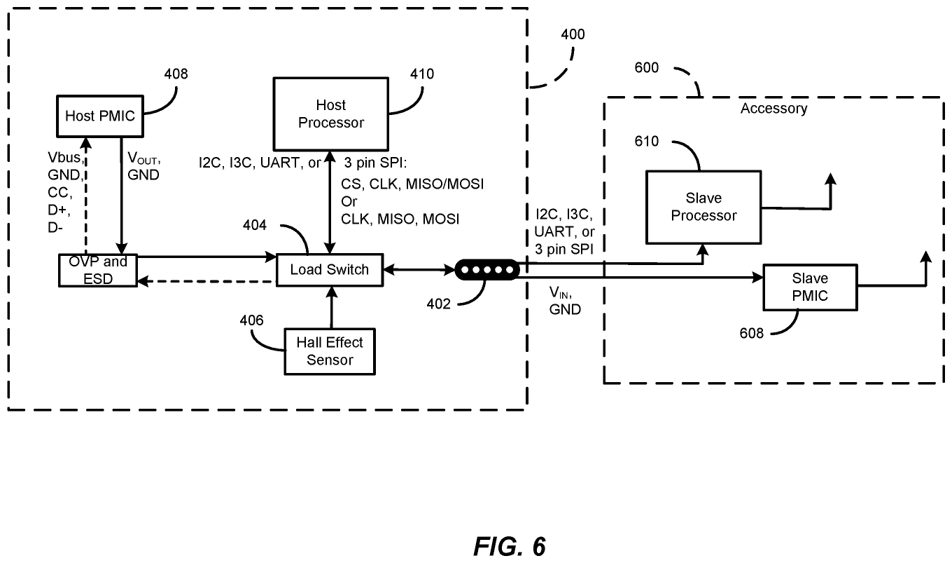

FIG. 1 is a flow diagram of an exemplary method of operation for a multi-purpose connector. As shown in this figure, at step 110 the systems described herein may detect when a multi-purpose connector, which includes at least one data terminal and at least one power terminal, has connected to at least one of a power source or a smart accessory. For example, a detection module 202 in FIG. 2 may detect when a multi-purpose connector 222 has connected to a power source (such as charger 500 in FIG. 5) and/or a smart accessory (such as accessory 600 in FIG. 6).

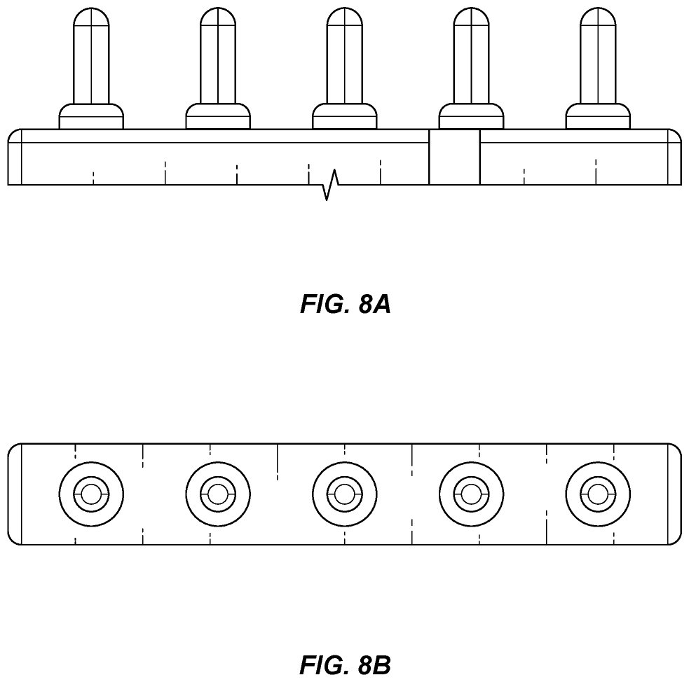

As used herein, the term “connector” may generally refer to an electrical component used to join electrical circuits. An example of a connector includes, but is not limited to, a terminal, a pin (e.g., a set of spring-loaded pogo pins), a post, a jack, a plug, a socket, etc. In addition, a “multi-purpose” connector may refer to an electrical component that is capable of alternatively connecting multiple electrical circuits, such as a circuit that delivers power and a circuit that delivers data. An example multi-purpose connector is shown in FIGS. 8A and 8B. As shown in this figure, a multi-purpose connector may be configured with a set of five pogo pins, with three of the pogo pins configured as data terminals and the remaining two pins configured as power terminals (i.e., voltage and ground).

In addition, the term “data terminal” may generally refer to an electrical interface employed for transmission of data. In contrast, the term “power terminal” may generally refer to an electrical interface used for providing power. Examples of terminals include one or more pins, such as spring-loaded pogo pins.

As used herein, the term “power source” may generally refer to an electrical power supply. Example power sources include, without limitation, chargers and batteries. A battery charger, or recharger, may refer to a device that provides electricity to convert into stored chemical energy for storage in an electrochemical cell by running an electric current through it. A “battery” may refer to a charged electrochemical cell.

In addition, the term “smart accessory” may generally refer to a device that is not integral to the operation of a computing device, and that has a slave processor capable of communicating with and responding to a host processor of the computing device. Smart accessories may provide or extend the functionality or features of the device to which it connects by including, for example, additional active displays, additional controls, remote control functionality, sensors, etc. Examples of smart accessories include, without limitation, smart watch bands (e.g., watch bands that include additional sensors, such as heart-rate sensors, blood oxygen level sensors, EMG sensors, etc.), smart docks, etc.

As used herein, the term “sensor” may generally refer to a device, module, machine, or subsystem configured to detect events or changes in its environment and send information regarding the same to other components. Example sensors include, without limitation, vision and imaging sensors, temperature sensors, radiation sensors, proximity sensors, pressure sensors, position sensors, photoelectric sensors, particle sensors, motion sensors, metal sensors, level sensors, leak sensors, humidity sensors, gas and chemical sensors, force sensors, flow sensors, flaw sensors, flame sensors, electrical potential sensors (such as EMG or EKG sensors), contact sensors, and non-contact sensors.

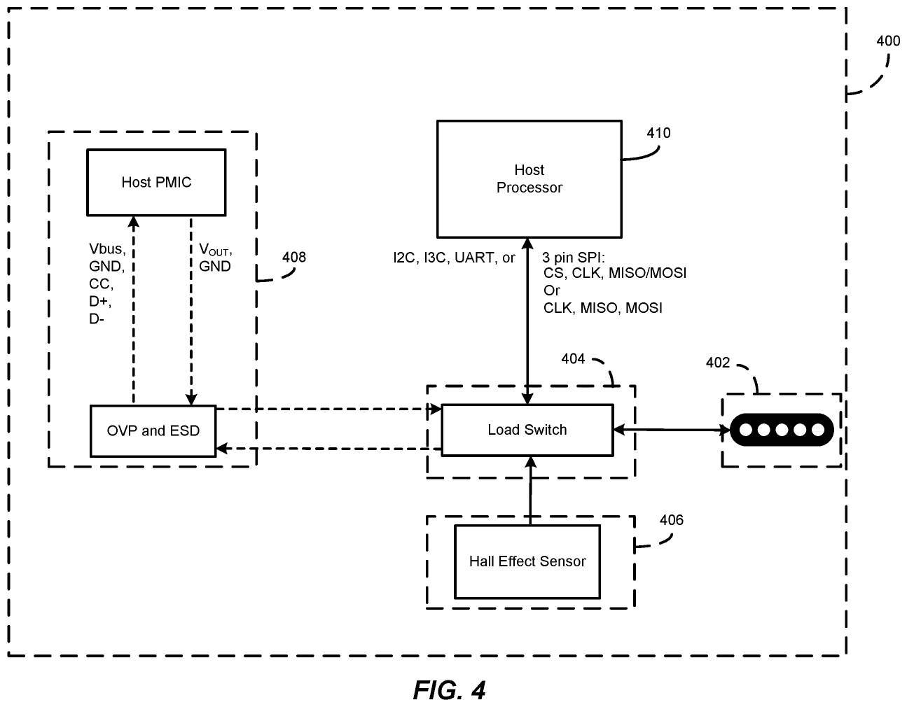

The systems described herein may perform step 110 in a variety of ways. For example, detection module 204 in FIG. 2 may determine that multi-purpose connector 222 has connected to a power source and/or a smart accessory based on received data (e.g., identifying data received from the connected device), sensed electrical circuit characteristics (e.g., sensed resistance and/or impedance), keyed detents configured with sensors, or any other type of sensor data. For example, and as described later in detail with reference to FIGS. 4-7, a Hall-effect sensor may be used to sense the strength of a magnetic field produced by a power source, a smart accessory, or both and determine, in response to detecting this magnetic field, whether the computing device has connected to a power source or a smart accessory.

As used herein, the term “Hall-effect sensor” may generally refer to a type of sensor that detects the presence and magnitude of a magnetic field using the Hall effect. The output voltage of a Hall-effect sensor may be directly proportional to the strength of the field. Hall-effect sensors may be used for proximity sensing, positioning, speed detection, and current sensing applications. In some examples, a Hall-effect sensor may be combined with threshold detection to act as a switch.

Returning to FIG. 1, at step 120 the system may connect the data terminal to a power management circuit of the computing device in response to detecting that the multi-purpose connector has connected to the power source. For example, connection module 206 in FIG. 2 may, in response to detection module 204 detecting that multi-purpose connector 222 has connected to a power source, cause (e.g., via switch 224) a data terminal of multi-purpose connector 222 to connect to power management circuit 228.

As used herein, the term “power management circuit” may generally refer to any electrical circuit that is used to manage power on an electronic device or in modules on devices that may have a range of voltages. A non-limiting example of a such a circuit is a power management integrated circuit (PMIC), which may refer to a class of integrated circuits that perform various functions related to power requirements. A PMIC may have one or more of the following functions: DC to DC conversion, battery charging, power source selection, voltage scaling, and power sequencing. A power management circuit may have additional components to provide over voltage protection (OVP) and/or electrostatic discharge (ESD) protection.

In addition, the term “switch” may generally refer to any device for making and breaking the connection in an electric circuit. For example, a switch may interrupt electric current or divert it from one conductor to another. Examples of switches include, without limitation, load switches, mechanical switches, electromechanical switches, toggle switches, rotary switches, biased switches, relays, flip flops, latches, MOSFETs, digital switches, and analog switches.

As used herein, the term “load switch” may generally refer to an electronic switch that can be used to turn on and turn off power supply rails in systems, similar to a relay or a discrete FET. Load switches may offer additional benefits to the systems described herein, including protection features that are often difficult to implement with discrete components. Load switches may be utilized to accomplish a variety of tasks, including, but not limited to, power distribution, power sequencing and power state transition, reducing leakage current in standby mode, inrush current control, and controlled power down.

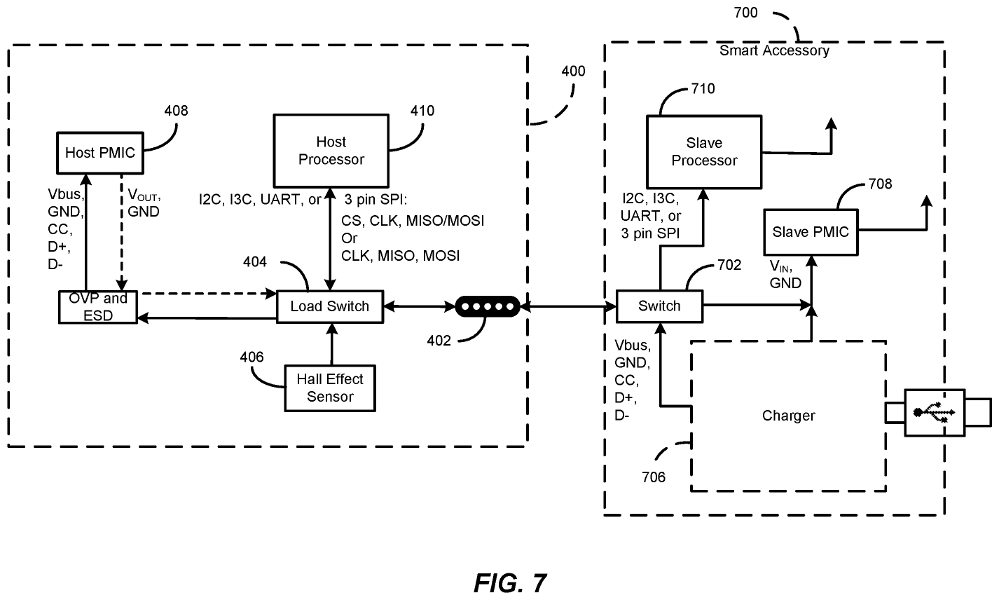

The systems described herein may perform step 120 in a variety of ways. For example, and as described later in detail with reference to FIGS. 5 and 7, a multi-purpose connector 402 may include five pogo pins that are used for charging a main battery of computing device 400 when a USB 2.0 compatible charger is connected. In this case, the pogo pin configuration may sequentially correspond to V_{BUS}, GND, CC, D+, D−. In this example, CC, D+, and D− are the data pins that serve as the data terminal(s). Specifically, these pins may provide a configuration channel (CC) and differential data lines (D+ and D−). The CC may be used for various purposes, such as to detect attachment of USB ports (e.g., a Source to a Sink), resolve cable orientation and twist connections to establish USB data bus routing, establish data roles between two attached ports, discover and configure V_{BUS}, etc. The differential data lines, D+ and D−, may inform the power management circuit of the current limit. Also, in this example, V_{BUS} and GND are power pins and serve as the power terminal(s). The switching may further be carried out by a mux/load switch, as explained in greater detail below.

In some examples, the multi-purpose connector described herein may utilize a standard protocol for compatibility purposes. An example standard protocol is Universal Serial Bus (USB). As used herein, the term “USB” generally refers to an industry standard that establishes specifications for cables, connectors, and protocols for connection, communication, and power supply (interfacing) between computers, peripherals, and other computers. A broad variety of USB hardware exists, including fourteen different connectors, of which USB-C is the most recent.

As used herein, the term “USB 2.0” generally refers to a version of USB released in April 2000, adding a higher maximum signaling rate of 480 Mbit/s (maximum theoretical data throughput 53 MByte/s), named High Speed or High Bandwidth, in addition to the USB 1.x Full Speed signaling rate of 12 Mbit/s (maximum theoretical data throughput 1.2 MByte/s). USB-C is backwards compatible with USB 2.0 and these terms may be used interchangeably herein. Although implementations of a novel computing device and method of operation are described herein with reference to USB 2.0, the disclosed techniques may also be implemented using other communication protocols not described herein.

Returning to FIG. 1, at step 130 the system described herein may connect the data terminal to a physical processor of the computing device in response to detecting that the multi-purpose connector has connected to the smart accessory. For example, connection module 206 in FIG. 2 may, in response to detection module 204 detecting that multi-purpose connector 222 has connected to a smart accessory, cause (e.g., via switch 224) a data terminal of multi-purpose connector 222 to connect to physical processor 230.

The systems described herein may perform step 130 in a variety of ways. In one example, and as described later in detail with reference to FIGS. 6 and 7, the five pogo pins of multi-purpose connector 402 may be used for power and communication with smart accessories when connected to a smart accessory. In this case, the pogo pin configuration may correspond to VOUT, GND, and a three-line (i.e., three pin) serial peripheral interface SPI (e.g., CS, CLK, MISO/MOSI), or other two-pin compatible interfaces (e.g., an I2C and/or I3C serial communication bus interface (such as serial clock (SCL) or standard data rate (SDR)), and/or a universal asynchronous receiver transmitter (UART) interface (for transmitting data (TX), receiving data (RX)), etc.). Here, VOUT and GND serve as the power terminal(s), and chip select (CS), clock (CLK), and MISO/MOSI, SDR, and TX, RX serve as the data terminal(s). For two-pin interfaces, the remaining pin may serve as an extra interrupt (INT), or may serve as an extra digital ground (GNDd). For SPI interfaces, the data pins may alternatively be configured as clock (CLK, SCL), master in slave out (MISO), and master out slave in (MOSI) for duplex communication. In some cases, the switching may also be carried out by a mux/load switch, as detailed later herein.

Steps 110-130 of method 100 may include additional operations. For example, step 120 may include connecting the power terminal to the power management circuit to provide a voltage bus (VBUS) connection in response to detecting that the multi-purpose connector has connected to the power source. Additionally, step 130 may include connecting the power terminal to the power management circuit to provide a voltage output connection in response to detecting that the multi-purpose connector has connected to the smart accessory. Also, step 110 may include detecting that the multi-purpose connector has connected to the power source at least in part by detecting, via a Hall-effect sensor, the connection of the multi-purpose connector to the power source. In such an implementation, connecting the power terminal to the power management circuit to provide a voltage bus connection at step 120 may include connecting the power terminal via a load switch that is responsive to the Hall-effect sensor.

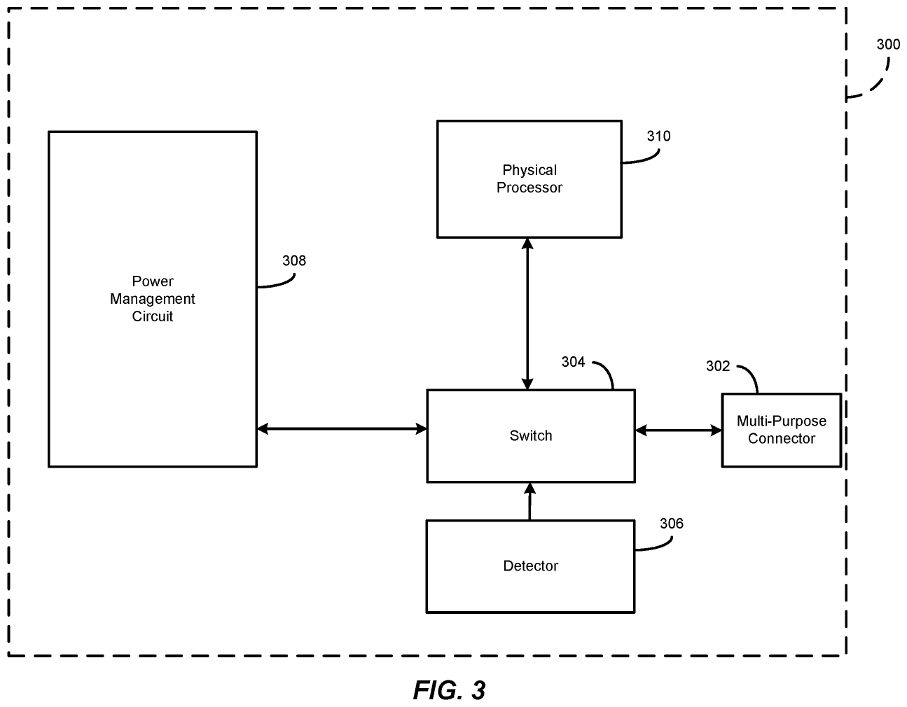

A computing device having a multi-purpose connector may be implemented in any suitable manner. Turning to FIG. 2, an exemplary computing device 200 includes at least one physical processor 230, physical memory 240 comprising computer-executable instructions such as modules 202, and additional elements 220, such as a multi-purpose connector 222, a switch 224, a detector 226, and/or a power management circuit 228. In some implementations, these additional elements may carry out the operations described above with reference to steps 110-130. In other implementations, one or more of these additional elements may instead be replaced by one or more modules 202. When executed by the physical processor 230, the modules 202 may cause physical processor 230 to carry out various operations. For example, detection module 204 may execute the procedures described above with reference to step 110 of method 100 of FIG. 1. Additionally, connection module 206 may execute the procedures described above with reference to steps 120 and/or 130 of method 100 of FIG. 1. Also, roll call/polling module 208 may recognize a connected smart accessory and set up a connection to physical processor 230 of the computing device 200. Further, modules 204-206 may perform additional operations as detailed below with reference to FIGS. 3-7.

Turning to FIG. 3, an example computing device 300 may include a multipurpose connector 302 connected to a switch 304. As detailed above, switch 304 may be responsive to a detector 306 to facilitate connections with power management circuit 308 and/or physical processor 310. Detector 306 may be any type of detector capable of determining if the multipurpose connector has connected to a power source, a smart accessory, or both. As detailed above, detector 306 may use one or more techniques, alone or in combination, to make this determination, including based on received data, sensed electrical circuit characteristics (e.g., sensed resistance and/or impedance), keyed detents configured with sensors, and/or based on any other type of sensor data (e.g., a Hall-effect sensor, photo sensor, proximity sensor, etc.).

FIG. 4 is a block diagram of an exemplary computing device 400 that includes a multi-purpose connector that incorporates a load switch that is responsive to a Hall-effect sensor. As shown in this figure, a multi-purpose connector 402 may include five pogo pins, as depicted in FIGS. 8A and 8B. In this example, computing device 400 may also include a load switch 404 that is responsive to a detector (which, in this case, is a Hall-effect sensor 406). As illustrated in this figure, load switch 404 may provide connection to a power management circuit (e.g., a power management integrated circuit (PMIC) 408) with overvoltage protection (OVP) and electrostatic discharge (ESD) protection. Further, the load switch may provide connection to a physical processor (e.g., host processor 410).

In one example, both the host PMIC 408 and the host processor 410 may be configured to use USB 2.0 protocol for power management and data communications. For example, the load switch 404 may be configured with at least one power terminal that provides V_{BUS} and GND to the power management circuit and at least one data terminal that provides CC, D+, and D− to the host PMIC 408. Also, the load switch 404 may be configured with a power terminal that provides V_{OUT} and GND to the multipurpose connector 402 and a data terminal that provides three-pin SPI to the host processor 410. In this way, the multi-purpose connector 402 can be used to provide power and data to the PMIC and also to provide power to, and facilitate data communications with, a smart accessory.

FIG. 5 is a block diagram illustrating an example in which the computing device of FIG. 4 is connected to a USB charger. As shown in this figure, a connection of the computing device 400 to a power source, such as charger 500, may be detected by the Hall-effect sensor 406. As an example, the detection may occur because the charger 500 has a permanent magnet that produces a magnetic field of sufficient strength to trigger Hall-effect sensor 406. When Hall-effect sensor 406 senses the magnetic field, then the load switch 404 may connect the multi-purpose connector 402 to the host PMIC 408 via an electrical path that provides V_{BUS}, GND, CC, D+, and D−, as previously described. However, the load switch may refrain from connecting another electrical path between the data terminal(s) of the multipurpose connector 402 and the host processor 410. In this way, the five pogo pins of the connector may provide power and data from the charger 500 to the host PMIC 408. When the charger is disconnected from the multi-purpose connector 402, the Hall-effect sensor 406 may cause load switch 404 to disconnect the electrical path so that the host PMIC 408 is no longer connected to the multi-purpose connector 402.

FIG. 6 is a block diagram illustrating an example in which the computing device of FIG. 4 is connected to a smart accessory. As shown in this figure, a connection of the computing device 400 to a smart accessory 600 may be detected at least in part by the Hall-effect sensor 406. As an example, the detection may occur because the smart accessory 600 lacks a permanent magnet, and thus does not produce a magnetic field of sufficient strength to trigger Hall-effect sensor 406. Thus, the connection to the smart accessory 600 may be detected by a combination of: (a) the load switch observing a change in electrical characteristics of a connection to the multi-purpose connector (e.g., a decrease in resistance); and (b) the Hall-effect sensor 406 failing to sense a magnetic field of sufficient strength to indicate connection to a power source. In this example, the load switch 404 may connect a power terminal (e.g., two pins) of the multi-purpose connector 402 to the host PMIC 408 by an electrical path that provides V_{OUT} and GND to a slave PMIC 608 of the smart accessory 600. Additionally, the load switch 404 may connect the data terminal (e.g., three pins) of the multi-purpose connector 402 to the host processor 410 by the other electrical path that provides three-pin SPI to a slave processor 610 of the smart accessory 600. In this way, the five pogo pins of the connector may provide power and data from the computing device 400 to the smart accessory 600.

When the smart accessory 600 is disconnected from the multi-purpose connector 402, the load switch 404 may detect this disconnection by observing a change in electrical characteristics of the connection to the multi-purpose connector (e.g., an increase in resistance) and disconnect the electrical paths so that the host PMIC 408 and the host processor 410 are no longer connected to the multi-purpose connector 402. Alternatively or additionally, the smart accessory may have another permanent magnet that produces a magnetic field having a different strength than that of the charger 500, and the load switch 404 may be configured with multiple magnetic field strength thresholds to help detect when the smart accessory has connected and disconnected. Such an arrangement may avoid inadvertent electrical discharge that may occur by connecting the host PMIC 408 to the multi-purpose connector 402 when the power terminal pins of the connector are accidentally shorted out. Alternatively or additionally, other types of sensors may be employed instead of or in combination with the Hall-effect sensor 406, as previously described.

FIG. 7 is a block diagram illustrating an example in which the computing device of FIG. 4 is connected to a smart accessory that includes a USB charger. As shown in this figure, a connection of the computing device 400 to a smart accessory 700 having a power source, such as charger 706, may be detected by the Hall-effect sensor 406. As an example, the detection may occur because the combination of smart accessory 700 and charger 706 has a magnet that produces a magnetic field of a particular strength that is configured to trigger detection of such a smart accessory 700. Alternatively or additionally, a magnet may be used in conjunction with any other observable criterion, such as data, a resistor having a predetermined resistance value that signals the type of accessory, a keyed detent combined with a proximity sensor, etc. When connection to the smart accessory 700 is detected, load switch 404 may then initially connect the multi-purpose connector 402 to the host PMIC 408 by an electrical path that provides V_{BUS}, GND, CC, D+, and D−, as previously described. The CC, D+, and D− values may be recorded in memory of the host PMIC 408, latched by the load switch 404, or preserved in any suitable manner so that the host PMIC 408 remains aware of the connector details and the current limit. Then, the load switch may disconnect the data terminal from the host PMIC 408 and connect the data terminal to the host processor 410. Meanwhile, the charger 706 of the smart accessory 700 may power both the host PMIC 408 of the computing device 400 and the slave PMIC 708 of the smart accessory 700, while another switch 704 of the smart accessory may switch an electrical path to connect a slave processor 710 of the accessory to the data terminal(s). In this way, the five pogo pins of the multipurpose connector may simultaneously provide power from the charger 500 to the host PMIC 408 and three-pin SPI from the host processor 410 to the slave processor 710. In some implementations, the accessory 700 may have an electromagnetic that only produces an electromagnet field when the charger 706 of the smart accessory 700 is connected to power. Thus, if the smart accessory 700 is disconnected from power, then the Hall-effect sensor 406 may detect the drop in the magnetic field strength and cause the load switch 404 to switch over to provide power to the smart accessory 700 in the same manner as described above with reference to FIG. 6. Similarly, switch 702 may switch over to receiving power from the computing device and provide that power to the slave PMIC 708.

The foregoing describes an exemplary multi-purpose connector for a computing device, such as a smart watch, that is able to charge the computing device when connected to a power source and to provide a data connection when connected to a smart accessory. As described above, the multi-purpose connector may have at least one data terminal and at least one power terminal. A detector may sense when the multi-purpose connector is connected to a power source and/or a smart accessory. A switch may connect the data terminal to a power management circuit of the computing device in response to detection of the connection to the power source. Alternatively, the switch may connect the data terminal to a physical processor of the computing device in response to detection of the connection to the smart accessory. A roll-call polling mechanism may recognize a connected smart accessory and initiate a connection to a processor of the computing device. Thus, the multi-purpose connector advantageously avoids the need for extra terminals or pins (in addition to the terminals or pins already used for charging the computing device) for powering and communicating with smart accessories.

### Microfluidic Devices

Microfluidic systems are small mechanical systems that involve the flow of fluids. Microfluidic systems can be used in many different fields, such as biomedical, chemical, genetic, biochemical, pharmaceutical, haptics, and other fields. A microfluidic valve is a component of some microfluidic systems and may be used for stopping, starting, or otherwise controlling flow of a fluid in a microfluidic system. Microfluidic valves may be actuated via fluid pressure, with a piezoelectric material, or a spring-loaded mechanism, for example. A microfluidic pump is a component of some microfluidic systems that generates fluid flow and/or pressure. Microfluidic pumps may include, or be used in conjunction with, microfluidic valves.

Haptic feedback mechanisms are designed to provide a physical sensation (e.g., vibration, pressure, heat, etc.) as an indication to a user. For example, vibrotactile devices include devices that may vibrate to provide haptic feedback to a user of a device. Some modern mobile devices (e.g., cell phones, tablets, mobile gaming devices, gaming controllers, etc.) include a vibrotactile device that informs the user through a vibration that an action has been taken. The vibration may indicate to the user that a selection has been made or a touch event has been sensed. Vibrotactile devices may also be used to provide an alert or signal to the user. Haptic feedback may be employed in artificial-reality systems (e.g., virtual-reality systems, augmented-reality systems, mixed-reality systems, hybrid-reality systems, etc.), such as by providing one or more haptic feedback mechanisms in a controller or a glove or other wearable device.

Various types of vibrotactile devices include piezoelectric devices, eccentric rotating mass devices, and linear resonant actuators. Such vibrotactile devices may include one or more elements that vibrate upon application of an electrical voltage. In the case of piezoelectric devices, an applied voltage may induce bending or other displacement in a piezoelectric material. Eccentric rotating mass devices induce vibration by rotating an off-center mass around an axle of an electromagnetic motor. Linear resonant actuators may include a mass on an end of a spring that is driven by a linear actuator to cause vibration.

The present disclosure is generally directed to microfluidic devices and systems. In some examples, microfluidic devices of the present disclosure may include a stator substrate that includes electrodes and at least one stator fluid passageway through the stator substrate. A rotor may be adjacent to the stator substrate and may be rotatable relative to the stator substrate. The rotor may include an electromagnetically sensitive material configured to receive a rotational force the electrodes of the stator substrate upon actuation of the electrodes and may also include at least one rotor fluid passageway through the rotor. The at least one rotor fluid passageway may be positioned to be selectively aligned and misaligned with the at least one stator fluid passageway depending on a rotational position of the rotor.

In additional examples, microfluidic devices of the present disclosure may include an acoustic standing wave generator and a microfluidic valve adjacent to the standing wave generator. The acoustic standing wave generator may include an acoustic diaphragm and an acoustic cavity within which a standing wave is generated by the acoustic diaphragm. The microfluidic valve may include a stator substrate and a rotor that is rotatable relative to the stator substrate. The stator substrate may include electrodes and at least one stator fluid passageway through the stator substrate. The rotor may include an electromagnetically sensitive material configured to receive a rotational force from the electrodes of the stator substrate upon actuation of the electrodes. The rotor may also include at least one rotor fluid passageway through the rotor. The at least one rotor fluid passageway may be positioned to be selectively aligned with the at least one stator fluid passageway at times that are synchronized with the standing wave generated by the acoustic standing wave generator.

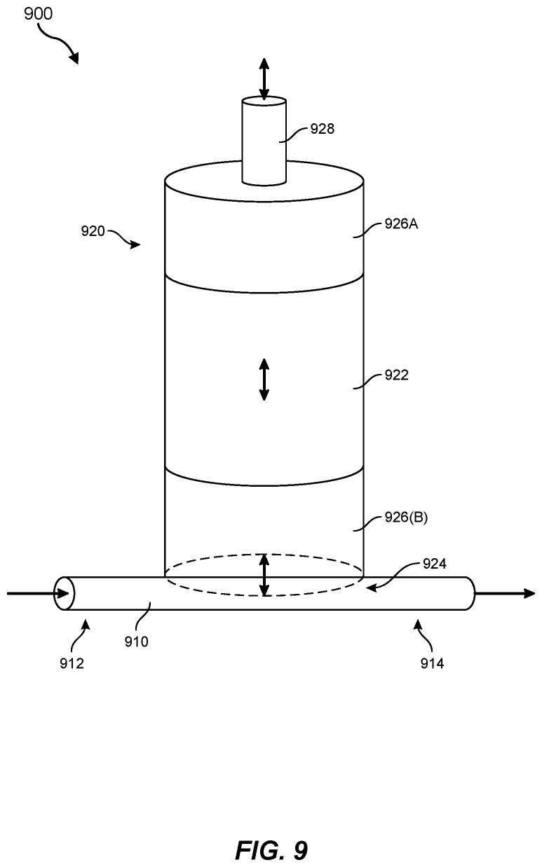

The present disclosure may include fluidic systems (e.g., haptic fluidic systems) that involve the control (e.g., stopping, starting, restricting, increasing, etc.) of fluid flow through a fluid channel. The control of fluid flow may be accomplished with a fluidic valve. FIG. 9 shows a schematic diagram of a fluidic valve 900 for controlling flow through a fluid channel 910, according to at least one embodiment of the present disclosure. Fluid from a fluid source (e.g., a pressurized fluid source, a fluid pump, etc.) may flow through the fluid channel 910 from an inlet port 912 to an outlet port 914, which may be operably coupled to, for example, a fluid-driven mechanism, another fluid channel, or a fluid reservoir.

Fluidic valve 900 may include a gate 920 for controlling the fluid flow through fluid channel 910. Gate 920 may include a gate transmission element 922, which may be a movable component that is configured to transmit an input force, pressure, or displacement to a restricting region 924 to restrict or stop flow through the fluid channel 910. Conversely, in some examples, application of a force, pressure, or displacement to gate transmission element 922 may result in opening restricting region 924 to allow or increase flow through the fluid channel 910. The force, pressure, or displacement applied to gate transmission element 922 may be referred to as a gate force, gate pressure, or gate displacement. Gate transmission element 922 may be a flexible element (e.g., an elastomeric membrane, a diaphragm, etc.), a rigid element (e.g., a movable piston, a lever, etc.), or a combination thereof (e.g., a movable piston or a lever coupled to an elastomeric membrane or diaphragm).

As illustrated in FIG. 9, gate 920 of fluidic valve 900 may include one or more gate terminals, such as an input gate terminal 926(A) and an output gate terminal 926(B) (collectively referred to herein as “gate terminals 926”) on opposing sides of gate transmission element 922. Gate terminals 926 may be elements for applying a force (e.g., pressure) to gate transmission element 922. By way of example, gate terminals 926 may each be or include a fluid chamber adjacent to gate transmission element 922. Alternatively or additionally, one or more of gate terminals 926 may include a solid component, such as a lever, screw, or piston, that is configured to apply a force to gate transmission element 922.

In some examples, a gate port 928 may be in fluid communication with input gate terminal 926(A) for applying a positive or negative fluid pressure within the input gate terminal 926(A). A control fluid source (e.g., a pressurized fluid source, a fluid pump, etc.) may be in fluid communication with gate port 928 to selectively pressurize and/or depressurize input gate terminal 926(A). In additional embodiments, a force or pressure may be applied at the input gate terminal 926(A) in other ways, such as with a piezoelectric element or an electromechanical actuator, etc.

In the embodiment illustrated in FIG. 9, pressurization of the input gate terminal 926(A) may cause the gate transmission element 922 to be displaced toward restricting region 924, resulting in a corresponding pressurization of output gate terminal 926(B). Pressurization of output gate terminal 926(B) may, in turn, cause restricting region 924 to partially or fully restrict to reduce or stop fluid flow through the fluid channel 910. Depressurization of input gate terminal 926(A) may cause gate transmission element 922 to be displaced away from restricting region 924, resulting in a corresponding depressurization of the output gate terminal 926(B). Depressurization of output gate terminal 926(B) may, in turn, cause restricting region 924 to partially or fully expand to allow or increase fluid flow through fluid channel 910. Thus, gate 920 of fluidic valve 900 may be used to control fluid flow from inlet port 912 to outlet port 914 of fluid channel 910.

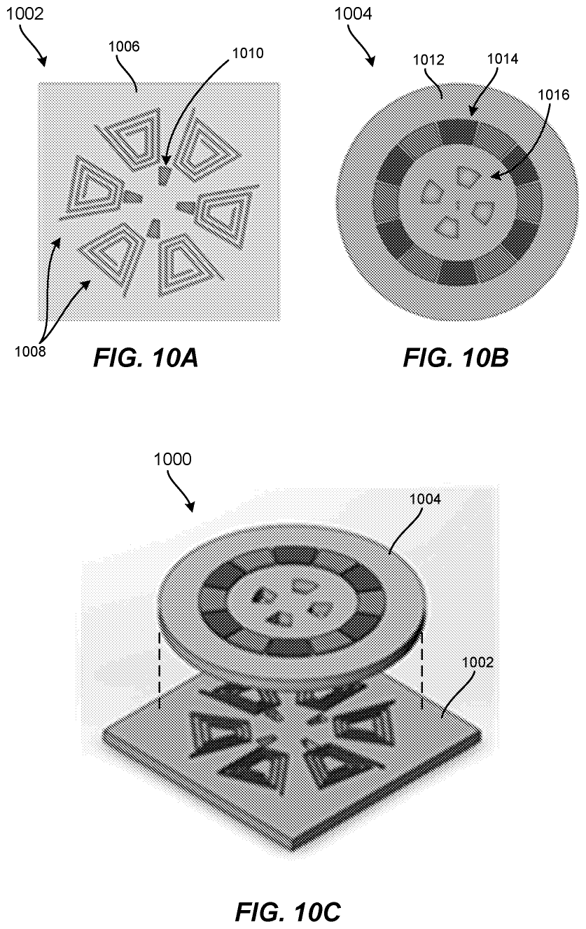

FIG. 10A is a plan view of a stator substrate 1002 of a microfluidic device 1000, according to at least one embodiment of the present disclosure. FIG. 10B is a plan view of a rotor 1004 of the microfluidic device 1000, according to at least one embodiment of the present disclosure. FIG. 10C is an exploded perspective view of the microfluidic device 1000 including the stator substrate 1002 of FIG. 10A and the rotor 1004 of FIG. 10B.

The stator substrate 1002 may include a stator base 1006 and electrodes 1008 on or in the stator base 1006. By way of example, the electrodes 1008 may include a plurality of conductive coils positioned in a circular arrangement on the stator base 1006. The stator base 1006 may include a non-conductive material, such as a printed-circuit board (PCB) substrate. The electrodes 1008 may be printed, etched, or otherwise formed on or in the stator base 1006. The electrodes 1008 may be selectively (e.g., individually, in pairs, in triplets, etc.) actuatable to induce a moving electromagnetic field. One or more stator fluid passageways 1010 may pass through the stator base 1006. For example, the stator substrate 1002 may include four stator fluid passageways 1010, which may be positioned in a circular arrangement, such as radially inside of the electrodes 1008.

The rotor 1004 may include a rotor base 1012 and an electromagnetically sensitive material 1014 positioned in a circular arrangement on or in the rotor base 1012. The electromagnetically sensitive material 1014 may be positioned to be directly over the electrodes 1008 when the rotor 1004 is assembled with the stator substrate 1002. The electromagnetically sensitive material 1014 may be configured to receive a rotational force from the electrodes 1008 upon actuation of the electrodes. By way of example and not limitation, the electromagnetically sensitive material 1014 may include a plurality of permanent magnets that have an alternating magnetic field (e.g., north up, south up, north up, south up, etc.).

One or more rotor fluid passageways 1016 may pass through the rotor base 1012. The rotor fluid passageways 1016 may be positioned in the rotor base 1012 to be over the stator fluid passageways 1010. Depending on the rotational position of the rotor 1004 relative to the stator substrate 1002, the rotor fluid passageways 1016 may be selectively aligned with (e.g., in fluid communication with) or misaligned with (e.g., not in fluid communication with) the stator fluid passageways 1010.

In addition, the rotor fluid passageways 1016 and stator fluid passageways 1010 may have a variety of sizes and shapes. For example, the rotor fluid passageways 1016 and stator fluid passageways 1010 may be shaped to allow flow from the stator substrate 1002 side to the rotor 1004 side. In another example, the rotor fluid passageways 1016 may be long enough to simultaneously communicate with two stator fluid passageways 1016, which may enable both an input and an output to be located on the stator substrate 1002 side. Other shapes and configurations of the rotor fluid passageways 1016 and the stator fluid passageways 1010 are also possible.

As illustrated in FIG. 10C, the rotor 1004 may be positioned adjacent to the stator substrate 1002 to form the microfluidic device 1000. The rotor 1004 may be rotatable relative to the stator substrate 1002. When an electromagnetic field is generated and/or moved by one or more of the electrodes 1008, a rotational force may be applied to the electromagnetically sensitive material 1014 to cause the rotor to rotate. As the electromagnetic field changes by actuating different electrodes 1008 in sequence (e.g., around the stator substrate 1002), the rotation of the rotor 1004 may be generated and/or controlled.

In some examples, the microfluidic device 1000 may be operated as a fluidic valve. The electrodes 1008 may be actuated in a manner to align the rotor fluid passageways 1016 with the stator fluid passageways 1008 to allow fluid (e.g., air, water, etc.) to flow through the microfluidic device 1000. When desired, the electrodes 1008 may be actuated differently to misalign the rotor fluid passageways 1016 with the stator fluid passageways 1008 to inhibit (e.g., block, reduce, etc.) the flow of the fluid through the microfluidic device 1000.

In additional examples, the microfluidic device 1000 may be operated as a fluidic oscillator by continuously rotating the rotor 1004 relative to the stator substrate 1002 to repeatedly switch between states of fluid flow and little or no fluid flow.

In some examples, the rotor 1004 may be configured to rotate back and forth between an open position (e.g., with the rotor fluid passageways 1016 aligned with the stator fluid passageways 1010) and a closed position (e.g., with the rotor fluid passageways 1016 misaligned with the stator fluid passageways 1010), without continuously rotating in a same rotational direction.

Depending on the implemented configuration, component size, material, etc., the microfluidic device 1000 may be capable of rotation of the rotor 1004 at frequencies of up to tens of hertz or one hundred hertz or more. Since there may be multiple rotor fluid passageways 1016 and stator fluid passageways 1010, the frequency of opening and closing fluid pathways may be a multiple of the rotational frequency. By way of example, four rotor fluid passageways 1016 may operate to allow and block fluid flow at four times the frequency of rotation of the rotor 1004. In some embodiments, the diameter of the rotor 1004 may be 1 cm or less, such as 1 cm, 5 mm, 4 mm, 2 mm, or less. In additional embodiments, the diameter of the rotor 1004 may be larger than 1 cm.

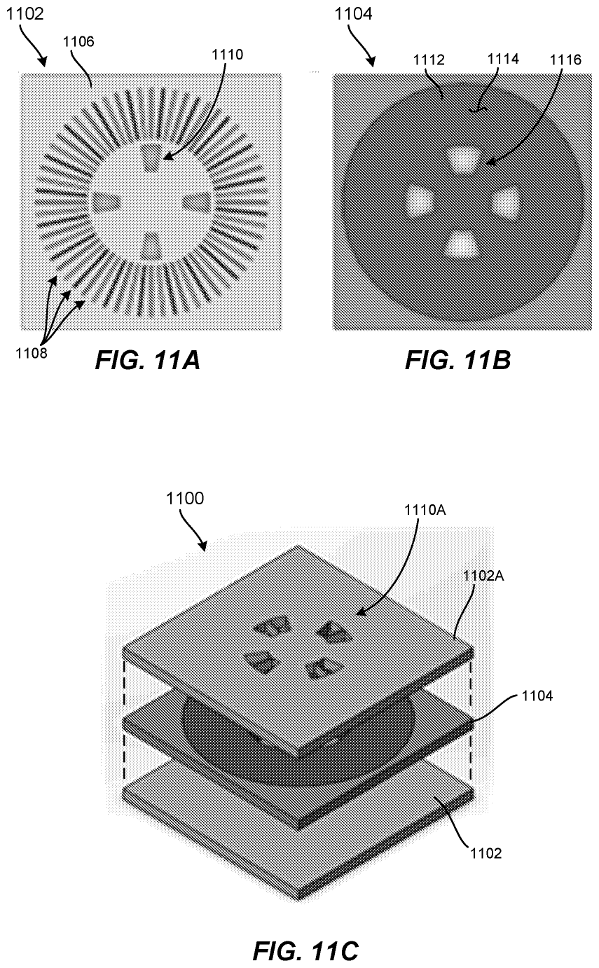

FIG. 11A is a plan view of a stator substrate 1102 of a microfluidic device 1100, according to at least one additional embodiment of the present disclosure. FIG. 11B is a plan view of a rotor 1104 of the microfluidic device 1100, according to at least one additional embodiment of the present disclosure. FIG. 11C is an exploded perspective view of the microfluidic device 1100 including the stator substrate 1102 of FIG. 11A and the rotor 1104 of FIG. 11B.

In some respects, the microfluidic device 1100 of FIGS. 11A-11C may be similar to the microfluidic device 1000 described above with reference to FIGS. 10A-10C. For example, the microfluidic device 1100 may include the stator substrate 1102 and the rotor 1104 positioned adjacent to and rotatable relative to the stator substrate 1102. The stator substrate 1102 may include a stator base 1106 and electrodes 1108 on or in the stator base. One or more stator fluid passageways 1110 may pass through the stator base 1106. The rotor 1104 may include a rotor base 1112, which may include electromagnetically sensitive material 1114. One or more rotor fluid passageways 1110 may pass through the rotor base 1112.

As shown in FIG. 11A, the electrodes 1108 may be arranged in triplets, including a first electrode, a second electrode, and a third electrode in each triplet. The first electrodes, second electrodes, and third electrodes of the triplets may be configured to be sequentially and repeatedly actuated to induce moving eddy currents in the electromagnetically sensitive material 1114 of the rotor 1104. For example, the first electrodes of the multiple triplets may be actuated at a first time, then the second electrodes may be actuated at a second time, and then the third electrodes may be actuated at a third time. This actuation sequence may be repeated starting with actuation of the first electrodes, followed by the second electrodes and then the third electrodes. The moving eddy currents induced in the electromagnetically sensitive material 1114 of the rotor 1104 may move as the actuation sequence proceeds, resulting in a rotational force being applied to the rotor 1104. A frequency of driving the first, second, and third electrodes may be matched to a lifetime of the eddy currents generated in the electromagnetically sensitive material 1114 of the rotor 1104.

The electromagnetically sensitive material 1114 of the rotor 1104 may include a doped semiconductor material, a ceramic material, a metal material, or another material suitable for generating moving eddy currents in the rotor 1104 in response to activation of the electrodes 1108.

As shown in FIG. 11C, the rotor 1104 may be positioned adjacent to (e.g., over) the stator substrate 1102 and may be rotatable relative to the stator substrate 1102. To facilitate the generation of moving eddy currents and consequently a rotational force in the rotor 1104, another stator substrate 1102A may be positioned adjacent to the rotor 1104 on an opposite side of the rotor 1104 relative to the stator substrate 1102. Additional stator fluid passageways 1110A may pass through the other stator substrate 1102A and may be aligned with the stator fluid passageways 1110 of the stator substrate 1102. The rotor 1104 may be positioned between (e.g., directly between) the stator substrate 1102 and the other stator substrate 1102A. When the rotor fluid passageways 1116 align with the stator fluid passageways 1110 and the additional stator fluid passageways 1110A, fluid may be allowed to flow through the fluidic device 1100. Otherwise, fluid flow may be inhibited (e.g., reduced or eliminated).

Depending on the implemented configuration, component size, material, etc., the microfluidic device 1100 may be capable of rotation of the rotor 1104 at frequencies of up to hundreds of hertz, one kilohertz, two kilohertz, or more.

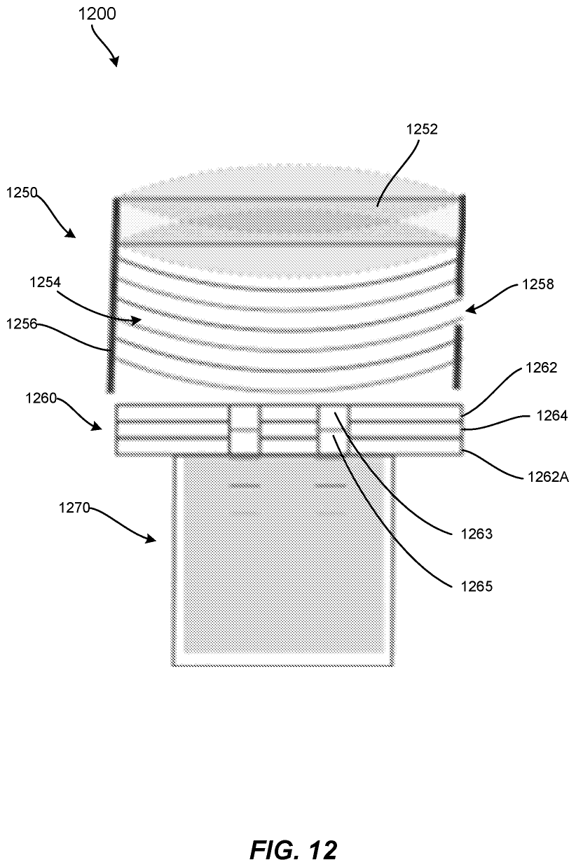

FIG. 12 is a cross-sectional side view of a microfluidic pump 1200 according to at least one embodiment of the present disclosure. The microfluidic pump 1200 may include an acoustic standing wave generator 1250 and a microfluidic valve 1260 adjacent to the acoustic standing wave generator 1250. An output 1270 may be fluidically coupled to an output of the microfluidic valve 1260. As explained below, the output 1270 may be pressurized or depressurized by synchronized opening of the microfluidic valve 1260 with a varying phase relative to a standing wave generated by the acoustic standing wave generator 1250.

The acoustic standing wave generator 1250 may include an acoustic diaphragm 1252 for generating a standing wave and an acoustic cavity 1254 within which the standing wave is generated. The acoustic diaphragm 1252 may include a piezoelectric disk, a voice coil actuator, a magnetic membrane, or the like. Movement of the acoustic diaphragm 1252 is represented by dashed lines in FIG. 12. The standing wave is represented in FIG. 12 by curved lines within the acoustic cavity 1254.

The acoustic cavity 1254 may be defined in part by at least one sidewall 1256. In some examples, an aperture 1258 may pass through the at least one sidewall 1256 at a median plane of the standing wave (e.g., at a halfway point of the acoustic cavity 1254). The acoustic cavity 1254 may be sized and shaped to operate as a resonant cavity for the standing wave generated by the acoustic diaphragm 1252.

The microfluidic valve 1260 may include a stator substrate 1262 and a rotor 1264 adjacent to the stator substrate 1262. The microfluidic valve 1260 may be the same as or similar to the microfluidic device 1000 described above with reference to FIGS. 10A-10C or the microfluidic device 1100 described above with reference to FIGS. 11A-11C. The microfluidic valve 1260 may include at least a stator substrate 1262 and a rotor 1264. The stator substrate 1262 may include at least one stator fluid passageway 1263 therethrough and the rotor 1264 may include at least one rotor fluid passageway 1265 therethrough. When the rotor fluid passageway(s) 1265 are aligned with the stator fluid passageways(s) 1263, fluid may be able to pass through the microfluidic valve 1260, such as from the acoustic cavity 1254 to the output 1270.

The opening of the microfluidic valve 1260 may be synchronized with the standing wave generated by the acoustic standing wave generator 1250. For example, at times when a high-pressure crest of the standing wave reaches the microfluidic valve 1260, the microfluidic valve 1260 may be opened to force fluid (e.g., air) through the microfluidic valve 1260 and into the output 1270. As the fluid leaves the acoustic cavity 1254 through the microfluidic valve 1260, additional fluid may flow into the acoustic cavity 1254 through the aperture 1258. Since the aperture 1258 is positioned at a median plane of the standing wave, the fluid inside the aperture 1258 may be at a neutral or low pressure and, therefore, may not be forced out of the aperture 1258. Conversely, at times when a low-pressure valley of the standing wave reaches the microfluidic valve 1260, the microfluidic valve 1260 may be closed to block fluid (e.g., air) from flowing through the microfluidic valve 1260 and into or out of the output 1270. In this manner, the microfluidic pump 1200 may pressurize the output 1270.

The microfluidic pump 1200 may also be operated in reverse to draw fluid (e.g., pressurized fluid) from the output 1270 into the acoustic cavity 1254 and out through the aperture 1258. To operate in this manner, at times when a low-pressure valley of the standing wave reaches the microfluidic valve 1260, the microfluidic valve 1260 may be opened to apply a negative pressure and to withdraw fluid (e.g., air or another compressible fluid) through the microfluidic valve 1260 from the output 1270 and into the acoustic cavity 1254. Excess fluid within the acoustic cavity 1254 may be forced out through the aperture 1258. Conversely, at times when a high-pressure valley of the standing wave reaches the microfluidic valve 1260, the microfluidic valve 1260 may be closed to block fluid (e.g., air) from flowing through the microfluidic valve 1260 and into or out of the output 1270. In this manner, the microfluidic pump 1200 may be used to withdraw fluid from the output 1270.

Operation of the microfluidic pump 1200 may be switched between pumping fluid into the output 1270 and drawing fluid out of the output 1270 as desired by simply changing the phase between the standing wave and the opening of the microfluidic valve 1260.

In some examples, the microfluidic valve 1260 may also include another stator substrate 1262A on an opposite side of the rotor 1264 from the stator substrate 1262, like the embodiment described above with reference to FIG. 11.

Accordingly, the present disclosure includes devices and systems that can be scaled to small sizes for microfluidics applications and that can be operated (e.g., at high frequencies) to open and close fluid pathways. These microfluidic devices and systems can be used for a variety of applications, including but not limited to haptics applications.

### Systems and Methods for Securing Board-to-Board Connections

Board-to-board connectors may be used in various electronics devices, including portable electronic devices such as augmented reality glasses or virtual-reality headsets. Board-to-board connectors may include, for example, metal leaf springs or plastic friction fit interfaces to hold the connectors in the mated position. The connectors may be designed such that a first mating cycle results in the highest insertion and retention force, but they can be un-mated if rework is necessary. A second mating may result in a lower mating and un-mating force because the connector may take a slight permanent set (the metal yields, plastic wears, etc.). Furthermore, even on a first mating cycle, when connectors may have adequate self-retention force, that force may not be sufficient to retain mating in drop or shock events, which may be a particularly acute risk with portable electronic devices.

For effective application of the mating process, the connectors may be subject to hold down brackets or foam to keep them in a mated position. However, space constraints in some devices (e.g., augmented-reality glasses) may make such traditional solutions unfeasible. One alternative to such traditional solutions may be to apply UV cure adhesives to mated pairs of connectors. Unfortunately, doing so may risk the adhesive creating an open circuit in the connector if the adhesive flows into the contacts. Furthermore, adhesive volume can be challenging to control and may create interference with other components. Also, adhesive may make rework more difficult or impossible: even if the connectors can be removed, the adhesive may prevent a new connector from being mated. Application of adhesive or a bracket may also involve additional time on an assembly line. One other option is to use a locking sleeve, but such a solution may also be impractical or impossible to implement in space-constrained designs.

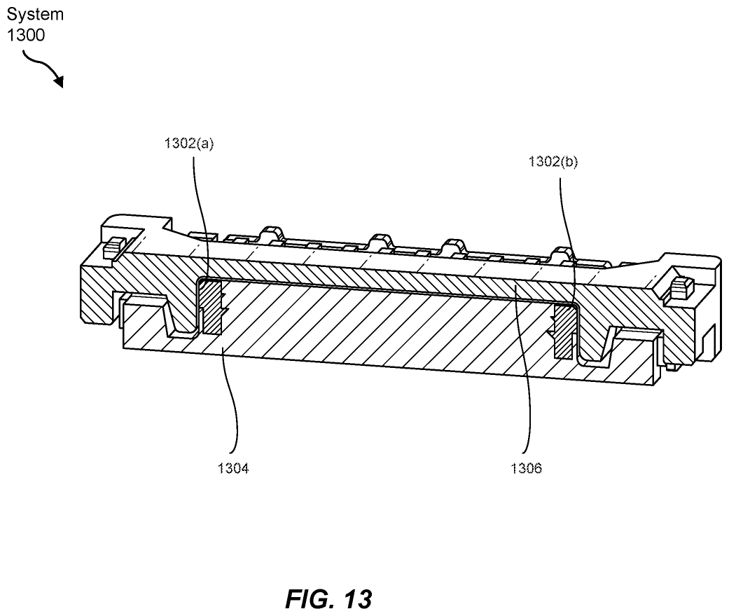

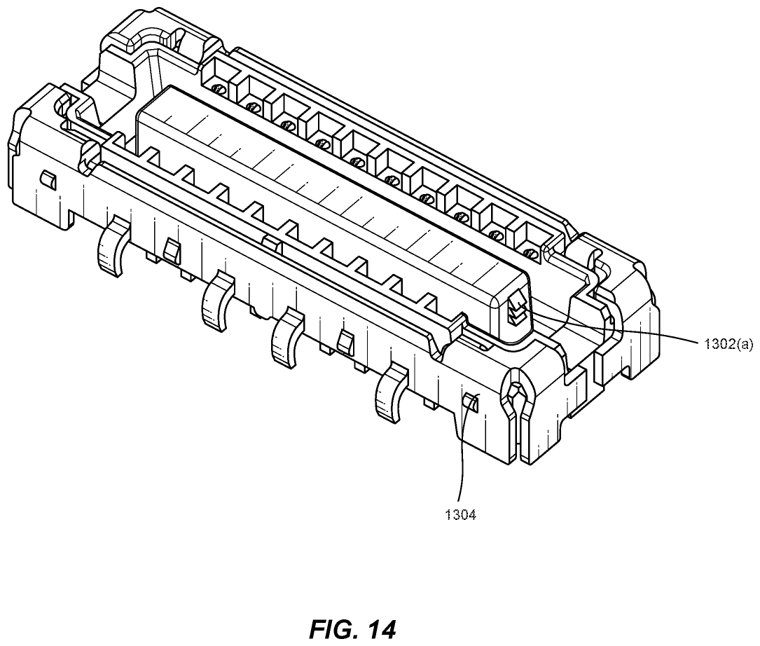

Embodiments of the present disclosure may address some or all of the deficiencies of alternative approaches by using retention barbs and/or contacts that are stitched or otherwise couple to each of their respective plastic housings. For example, FIG. 13 shows a mating system 1300 with barbed connectors 1302(a) and 1302(b) coupled to a first board 1304 to hold the first board 1304 in a mated position with a second board 1306. FIG. 14 shows another perspective of board 1304 with barbs 1302(a). While FIGS. 13 and 14 show barbs, any other suitable type of contact may be used to secure two boards in a mated position, and such contacts and/or barbs may be an integral part of, or attached to, either or both of a set of boards that are being mated. Such barbs and contacts may result in a relatively high-retention force, may be more compact than alternative solutions, and may be suitable for use in mobile devices that may experience occasional shock or impact events (e.g., augmented-reality glasses). Such barbs and contacts may also be used in any other type or form of device with board-to-board connectors.

### Embedded Micro-Coaxial Wire in a Rigid Substrate

Product density requirements and freeform organic shapes of those products motivate use of rigid flexible printed circuit assemblies (RFPCAs) to route all electronics. However, flexible printed circuit (FPC) routing constrains design and manufacture to use of planar bends. Stated differently, FPC routing cannot be used to make compound bends in multiple axes simultaneously. FPC routing also requires relatively large bend radii that limit packaging density.

Cable (e.g., either discrete wire or micro-coaxial wire) allows design and manufacture to make of very organic freeform bends that integrate service loops, route around various modules, and generally follow organic product surfacing more easily. Cabling is also much more capable of surviving dynamic bending versus an FPC. Currently available solutions require space for connecting a wire to a PCB with either a hot-bar solder joint or a connector.

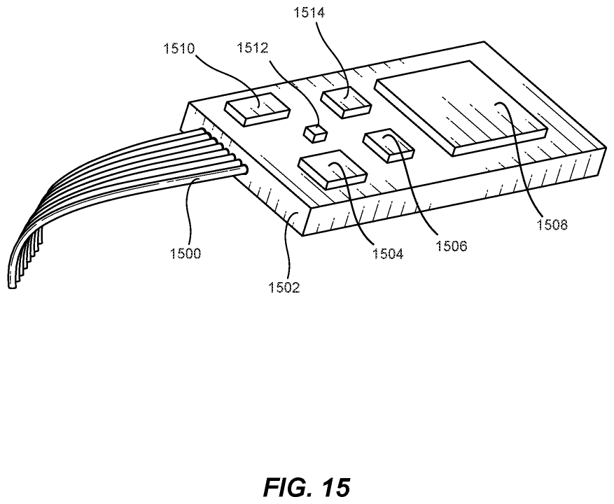

As illustrated in FIG. 15, an electronics routing system 1500 includes a wire 1501 embedded into an inner layer of an FPC or printed circuit board (PCB) substrate 1502 reduces the space required, and such embedding can be performed in a variety of ways. For example, embedding can be performed with an embedded die lamination process. Alternatively or additionally, embedding can be performed with a sandwiched pair of PCBs with wires hot bar soldered to one of them. Embedding the wire increases space on the outside of the PCB for various components 1504-1514 and/or connectors.

### Miniature Micro-Coaxial-to-Board Interconnect Frogboard

Space constrained electronics systems often lack room for existing electrical interconnects (e.g., connectors), particularly Wire-To-Board (WTB) interconnects. Existing solutions can be too large in one or all dimensions (X, Y, and Z). These issues can be exacerbated by a need to run high-speed signals (e.g., >5 Ghz) through these interconnects with low resistance.

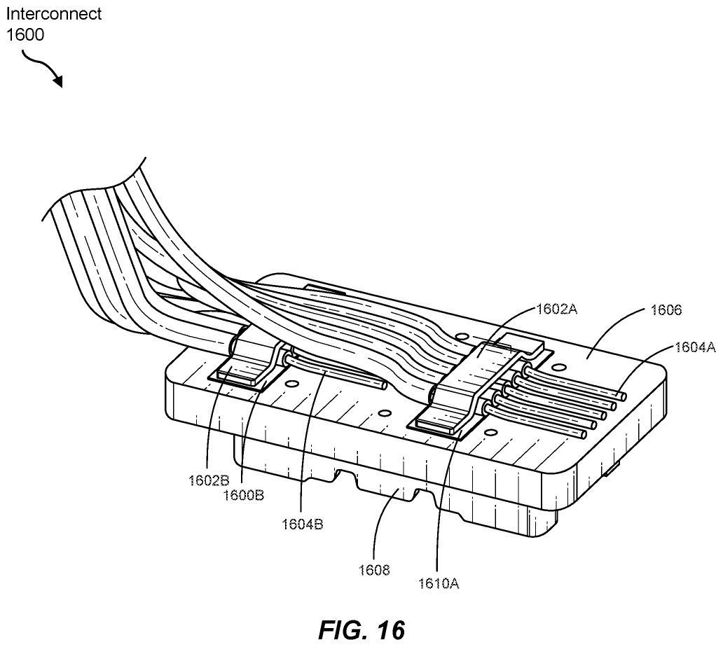

Existing WTB connectors typically use a mechanical crimp to retain/connect the wires. Referring to FIG. 16, the disclosed WTB interconnect 1600 uses hot bar solder 1602A and 1602B to reduce the size of the interconnect to a significantly smaller footprint. In an example, a WTB connector hot-bar-solders two rows (e.g., two or more) of micro-coaxial wire (MCX) 1604A and 1604B to a small, printed circuit board assembly (PCBA) 1606 with a small board-to-board (BTB) connector 1608 on the opposite side. Stacking the MCX 1604A and 1604B in two rows allows separation of ground on one set of MCX shields (e.g., the outer conductor of the MCX 1604A) and power on the other set (e.g., the inner conductor of the MCX 1604B). Separate ground bars 1610A and 1610B can tie all of the shields together. Separation of ground and power on a splitshield structure of the BTB shielding can also be performed, further reducing the interconnect size due to no requirement for an individual pin for power/ground.

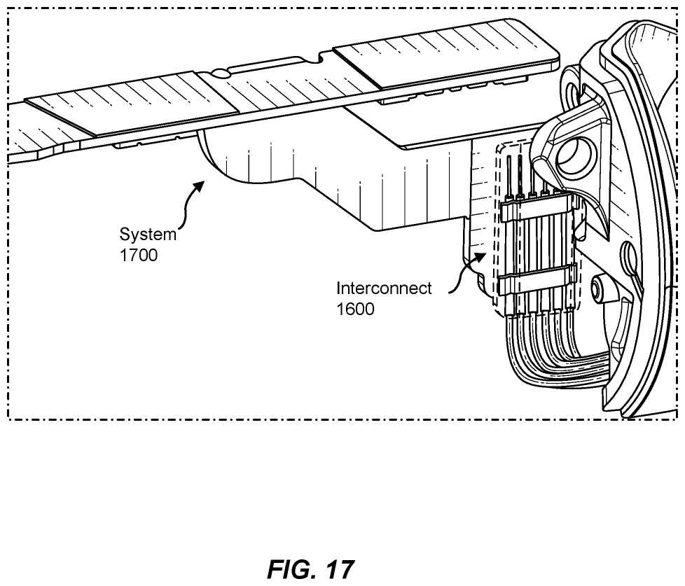

Referring to FIG. 17, embodiments of the WTC interconnect 1600 may be included or implemented in conjunction with an artificial-reality system 1700. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

### Artificial Reality Applications

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

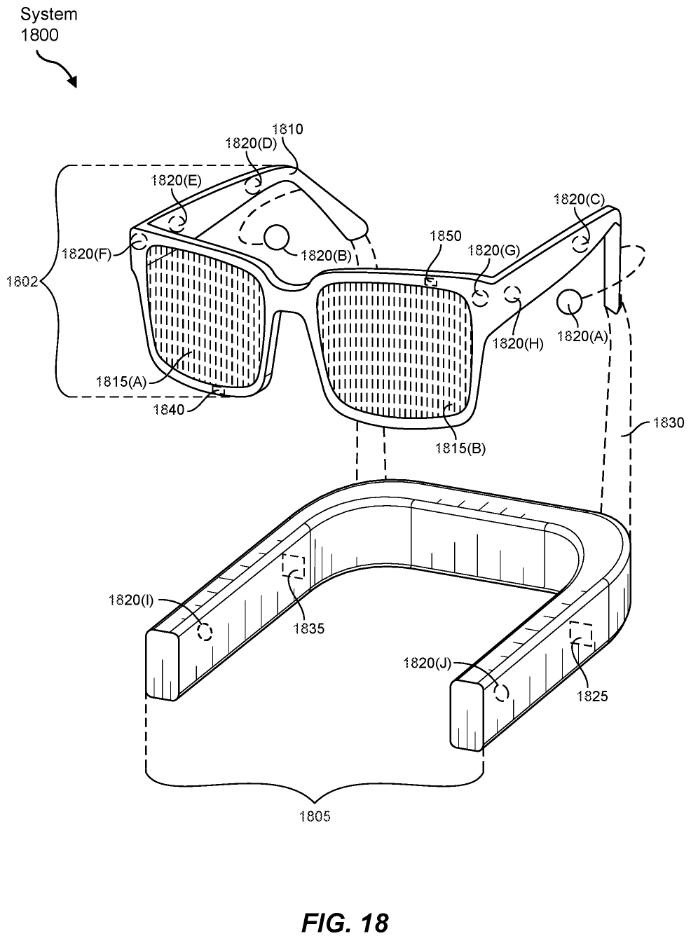

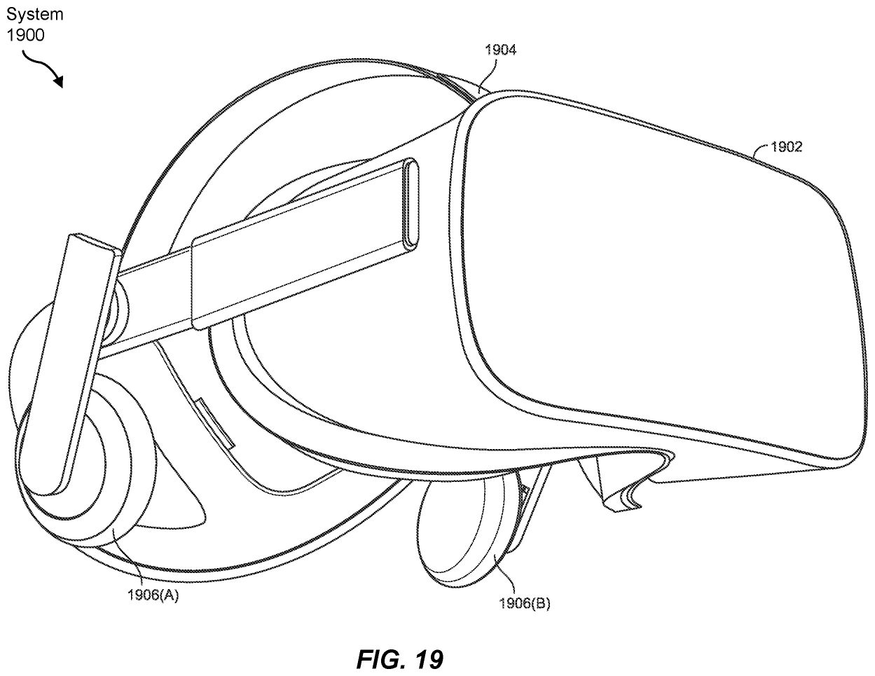

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1800 in FIG. 18) or that visually immerses a user in an artificial reality (such as, e.g., virtual-reality system 1900 in FIG. 19). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 18, augmented-reality system 1800 may include an eyewear device 1802 with a frame 1810 configured to hold a left display device 1815(A) and a right display device 1815(B) in front of a user's eyes. Display devices 1815(A) and 1815(B) may act together or independently to present an image or series of images to a user. While augmented-reality system 1800 includes two displays, embodiments of this disclosure may be implemented in augmented-reality systems with a single NED or more than two NEDs.

In some embodiments, augmented-reality system 1800 may include one or more sensors, such as sensor 1840. Sensor 1840 may generate measurement signals in response to motion of augmented-reality system 1800 and may be located on substantially any portion of frame 1810. Sensor 1840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1800 may or may not include sensor 1840 or may include more than one sensor. In embodiments in which sensor 1840 includes an IMU, the IMU may generate calibration data based on measurement signals from sensor 1840. Examples of sensor 1840 may include, without limitation, accelerometers, gyroscopes, magnetometers, other suitable types of sensors that detect motion, sensors used for error correction of the IMU, or some combination thereof.

In some examples, augmented-reality system 1800 may also include a microphone array with a plurality of acoustic transducers 1820(A)-1820(J), referred to collectively as acoustic transducers 1820. Acoustic transducers 1820 may represent transducers that detect air pressure variations induced by sound waves. Each acoustic transducer 1820 may be configured to detect sound and convert the detected sound into an electronic format (e.g., an analog or digital format). The microphone array in FIG. 18 may include, for example, ten acoustic transducers: 1820(A) and 1820(B), which may be designed to be placed inside a corresponding ear of the user, acoustic transducers 1820(C), 1820(D), 1820(E), 1820(F), 1820(G), and 1820(H), which may be positioned at various locations on frame 1810, and/or acoustic transducers 1820(1) and 1820(J), which may be positioned on a corresponding neckband 1805.

In some embodiments, one or more of acoustic transducers 1820(A)-(J) may be used as output transducers (e.g., speakers). For example, acoustic transducers 1820(A) and/or 1820(B) may be earbuds or any other suitable type of headphone or speaker.

The configuration of acoustic transducers 1820 of the microphone array may vary. While augmented-reality system 1800 is shown in FIG. 18 as having ten acoustic transducers 1820, the number of acoustic transducers 1820 may be greater or less than ten. In some embodiments, using higher numbers of acoustic transducers 1820 may increase the amount of audio information collected and/or the sensitivity and accuracy of the audio information. In contrast, using a lower number of acoustic transducers 1820 may decrease the computing power required by an associated controller 1850 to process the collected audio information. In addition, the position of each acoustic transducer 1820 of the microphone array may vary. For example, the position of an acoustic transducer 1820 may include a defined position on the user, a defined coordinate on frame 1810, an orientation associated with each acoustic transducer 1820, or some combination thereof.

Acoustic transducers 1820(A) and 1820(B) may be positioned on different parts of the user's ear, such as behind the pinna, behind the tragus, and/or within the auricle or fossa. Or, there may be additional acoustic transducers 1820 on or surrounding the ear in addition to acoustic transducers 1820 inside the ear canal. Having an acoustic transducer 1820 positioned next to an ear canal of a user may enable the microphone array to collect information on how sounds arrive at the ear canal. By positioning at least two of acoustic transducers 1820 on either side of a user's head (e.g., as binaural microphones), augmented-reality device 1800 may simulate binaural hearing and capture a 3D stereo sound field around about a user's head. In some embodiments, acoustic transducers 1820(A) and 1820(B) may be connected to augmented-reality system 1800 via a wired connection 1830, and in other embodiments acoustic transducers 1820(A) and 1820(B) may be connected to augmented-reality system 1800 via a wireless connection (e.g., a BLUETOOTH connection). In still other embodiments, acoustic transducers 1820(A) and 1820(B) may not be used at all in conjunction with augmented-reality system 1800.

Acoustic transducers 1820 on frame 1810 may be positioned in a variety of different ways, including along the length of the temples, across the bridge, above or below display devices 1815(A) and 1815(B), or some combination thereof. Acoustic transducers 1820 may also be oriented such that the microphone array is able to detect sounds in a wide range of directions surrounding the user wearing the augmented-reality system 1800. In some embodiments, an optimization process may be performed during manufacturing of augmented-reality system 1800 to determine relative positioning of each acoustic transducer 1820 in the microphone array.

In some examples, augmented-reality system 1800 may include or be connected to an external device (e.g., a paired device), such as neckband 1805. Neckband 1805 generally represents any type or form of paired device. Thus, the following discussion of neckband 1805 may also apply to various other paired devices, such as charging cases, smart watches, smart phones, wrist bands, other wearable devices, hand-held controllers, tablet computers, laptop computers, other external compute devices, etc.

As shown, neckband 1805 may be coupled to eyewear device 1802 via one or more connectors. The connectors may be wired or wireless and may include electrical and/or non-electrical (e.g., structural) components. In some cases, eyewear device 1802 and neckband 1805 may operate independently without any wired or wireless connection between them. While FIG. 18 illustrates the components of eyewear device 1802 and neckband 1805 in example locations on eyewear device 1802 and neckband 1805, the components may be located elsewhere and/or distributed differently on eyewear device 1802 and/or neckband 1805. In some embodiments, the components of eyewear device 1802 and neckband 1805 may be located on one or more additional peripheral devices paired with eyewear device 1802, neckband 1805, or some combination thereof.

Pairing external devices, such as neckband 1805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1800 may be provided by a paired device or shared between a paired device and an eyewear device, thus reducing the weight, heat profile, and form factor of the eyewear device overall while still retaining desired functionality. For example, neckband 1805 may allow components that would otherwise be included on an eyewear device to be included in neckband 1805 since users may tolerate a heavier weight load on their shoulders than they would tolerate on their heads. Neckband 1805 may also have a larger surface area over which to diffuse and disperse heat to the ambient environment. Thus, neckband 1805 may allow for greater battery and computation capacity than might otherwise have been possible on a stand-alone eyewear device. Since weight carried in neckband 1805 may be less invasive to a user than weight carried in eyewear device 1802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1805 may be communicatively coupled with eyewear device 1802 and/or to other devices. These other devices may provide certain functions (e.g., tracking, localizing, depth mapping, processing, storage, etc.) to augmented-reality system 1800. In the embodiment of FIG. 18, neckband 1805 may include two acoustic transducers (e.g., 1820(1) and 1820(J)) that are part of the microphone array (or potentially form their own microphone subarray). Neckband 1805 may also include a controller 1825 and a power source 1835.

Acoustic transducers 1820(1) and 1820(J) of neckband 1805 may be configured to detect sound and convert the detected sound into an electronic format (analog or digital). In the embodiment of FIG. 18, acoustic transducers 1820(1) and 1820(J) may be positioned on neckband 1805, thereby increasing the distance between the neckband acoustic transducers 1820(1) and 1820(J) and other acoustic transducers 1820 positioned on eyewear device 1802. In some cases, increasing the distance between acoustic transducers 1820 of the microphone array may improve the accuracy of beamforming performed via the microphone array. For example, if a sound is detected by acoustic transducers 1820(C) and 1820(D) and the distance between acoustic transducers 1820(C) and 1820(D) is greater than, e.g., the distance between acoustic transducers 1820(D) and 1820(E), the determined source location of the detected sound may be more accurate than if the sound had been detected by acoustic transducers 1820(D) and 1820(E).

Controller 1825 of neckband 1805 may process information generated by the sensors on neckband 1805 and/or augmented-reality system 1800. For example, controller 1825 may process information from the microphone array that describes sounds detected by the microphone array. For each detected sound, controller 1825 may perform a direction-of-arrival (DOA) estimation to estimate a direction from which the detected sound arrived at the microphone array. As the microphone array detects sounds, controller 1825 may populate an audio data set with the information. In embodiments in which augmented-reality system 1800 includes an inertial measurement unit, controller 1825 may compute all inertial and spatial calculations from the IMU located on eyewear device 1802. A connector may convey information between augmented-reality system 1800 and neckband 1805 and between augmented-reality system 1800 and controller 1825. The information may be in the form of optical data, electrical data, wireless data, or any other transmittable data form. Moving the processing of information generated by augmented-reality system 1800 to neckband 1805 may reduce weight and heat in eyewear device 1802, making it more comfortable to the user.

Power source 1835 in neckband 1805 may provide power to eyewear device 1802 and/or to neckband 1805. Power source 1835 may include, without limitation, lithium ion batteries, lithium-polymer batteries, primary lithium batteries, alkaline batteries, or any other form of power storage. In some cases, power source 1835 may be a wired power source. Including power source 1835 on neckband 1805 instead of on eyewear device 1802 may help better distribute the weight and heat generated by power source 1835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1900 in FIG. 19, that mostly or completely covers a user's field of view. Virtual-reality system 1900 may include a front rigid body 1902 and a band 1904 shaped to fit around a user's head. Virtual-reality system 1900 may also include output audio transducers 1906(A) and 1906(B). Furthermore, while not shown in FIG. 19, front rigid body 1902 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 1800 and/or virtual-reality system 1900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1800 and/or virtual-reality system 1900 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1800 and/or virtual-reality system 1900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 1800 and 1900 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

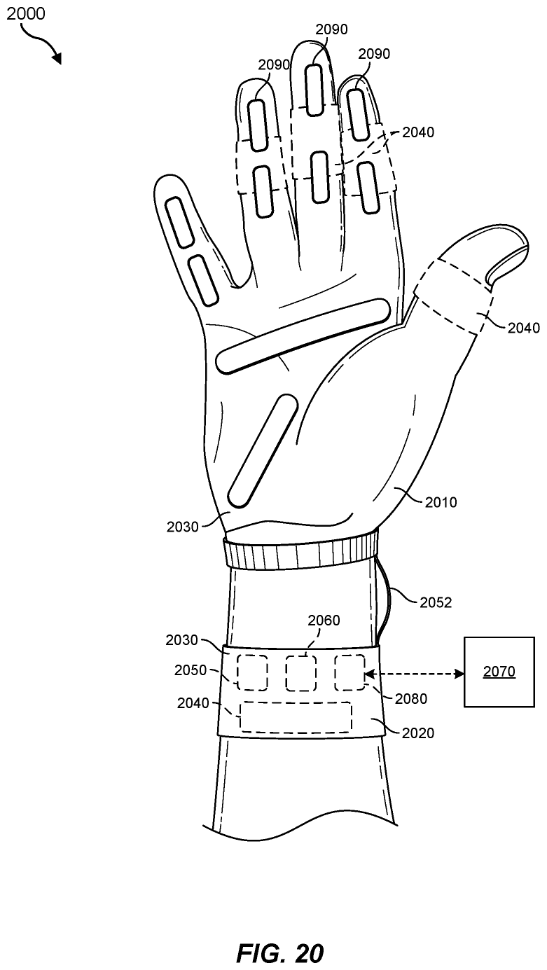

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 20 illustrates a vibrotactile system 2000 in the form of a wearable glove (haptic device 2010) and wristband (haptic device 2020). Haptic device 2010 and haptic device 2020 are shown as examples of wearable devices that include a flexible, wearable textile material 2030 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 2040 may be positioned at least partially within one or more corresponding pockets formed in textile material 2030 of vibrotactile system 2000. Vibrotactile devices 2040 may be positioned in locations to provide a vibrating sensation (e.g., haptic feedback) to a user of vibrotactile system 2000. For example, vibrotactile devices 2040 may be positioned against the user's finger(s), thumb, or wrist, as shown in FIG. 20. Vibrotactile devices 2040 may, in some examples, be sufficiently flexible to conform to or bend with the user's corresponding body part(s).

A power source 2050 (e.g., a battery) for applying a voltage to the vibrotactile devices 2040 for activation thereof may be electrically coupled to vibrotactile devices 2040, such as via conductive wiring 2052. In some examples, each of vibrotactile devices 2040 may be independently electrically coupled to power source 2050 for individual activation. In some embodiments, a processor 2060 may be operatively coupled to power source 2050 and configured (e.g., programmed) to control activation of vibrotactile devices 2040.

Vibrotactile system 2000 may be implemented in a variety of ways. In some examples, vibrotactile system 2000 may be a standalone system with integral subsystems and components for operation independent of other devices and systems. As another example, vibrotactile system 2000 may be configured for interaction with another device or system 2070. For example, vibrotactile system 2000 may, in some examples, include a communications interface 2080 for receiving and/or sending signals to the other device or system 2070. The other device or system 2070 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 2080 may enable communications between vibrotactile system 2000 and the other device or system 2070 via a wireless (e.g., Wi-Fi, BLUETOOTH, cellular, radio, etc.) link or a wired link. If present, communications interface 2080 may be in communication with processor 2060, such as to provide a signal to processor 2060 to activate or deactivate one or more of the vibrotactile devices 2040.

Vibrotactile system 2000 may optionally include other subsystems and components, such as touch-sensitive pads 2090, pressure sensors, motion sensors, position sensors, lighting elements, and/or user interface elements (e.g., an on/off button, a vibration control element, etc.). During use, vibrotactile devices 2040 may be configured to be activated for a variety of different reasons, such as in response to the user's interaction with user interface elements, a signal from the motion or position sensors, a signal from the touch-sensitive pads 2090, a signal from the pressure sensors, a signal from the other device or system 2070, etc.

Although power source 2050, processor 2060, and communications interface 2080 are illustrated in FIG. 20 as being positioned in haptic device 2020, the present disclosure is not so limited. For example, one or more of power source 2050, processor 2060, or communications interface 2080 may be positioned within haptic device 2010 or within another wearable textile.

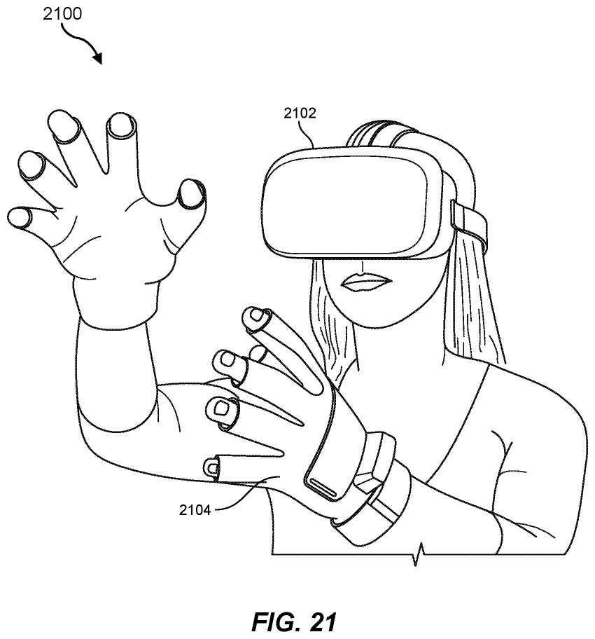

Haptic wearables, such as those shown in and described in connection with FIG. 20, may be implemented in a variety of types of artificial-reality systems and environments. FIG. 21 shows an example artificial-reality environment 2100 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 2102 generally represents any type or form of virtual-reality system, such as virtual-reality system 1900 in FIG. 19. Haptic device 2104 generally represents any type or form of wearable device, worn by a user of an artificial-reality system, that provides haptic feedback to the user to give the user the perception that he or she is physically engaging with a virtual object. In some embodiments, haptic device 2104 may provide haptic feedback by applying vibration, motion, and/or force to the user. For example, haptic device 2104 may limit or augment a user's movement. To give a specific example, haptic device 2104 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 2104 to send action requests to a console. Examples of action requests include, without limitation, requests to start an application and/or end the application and/or requests to perform a particular action within the application.

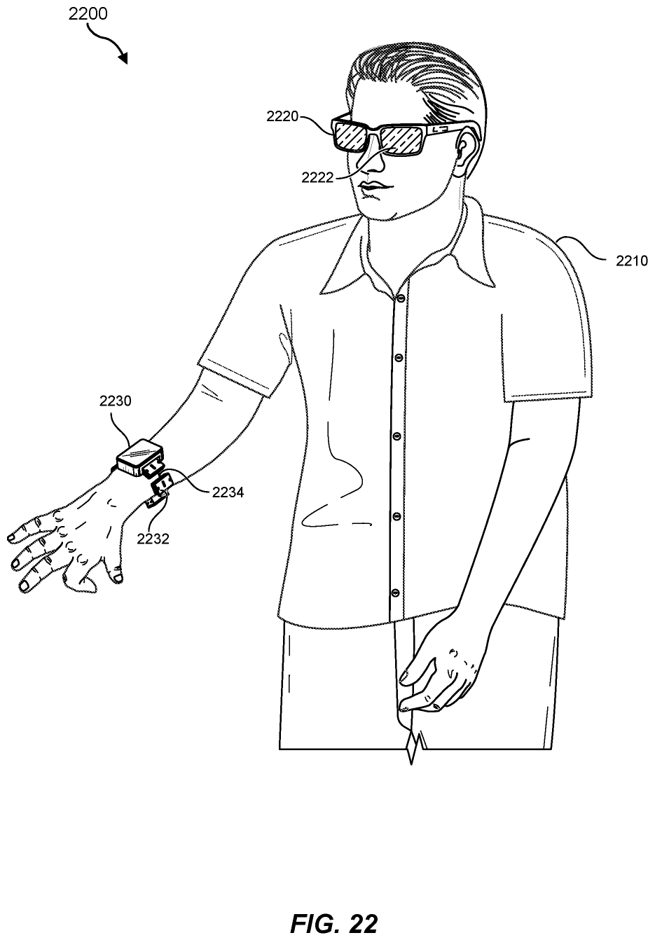

While haptic interfaces may be used with virtual-reality systems, as shown in FIG. 21, haptic interfaces may also be used with augmented-reality systems, as shown in FIG. 22. FIG. 22 is a perspective view of a user 2210 interacting with an augmented-reality system 2200. In this example, user 2210 may wear a pair of augmented-reality glasses 2220 that may have one or more displays 2222 and that are paired with a haptic device 2230. In this example, haptic device 2230 may be a wristband that includes a plurality of band elements 2232 and a tensioning mechanism 2234 that connects band elements 2232 to one another.

One or more of band elements 2232 may include any type or form of actuator suitable for providing haptic feedback. For example, one or more of band elements 2232 may be configured to provide one or more of various types of cutaneous feedback, including vibration, force, traction, texture, and/or temperature. To provide such feedback, band elements 2232 may include one or more of various types of actuators. In one example, each of band elements 2232 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 2010, 2020, 2104, and 2230 may include any suitable number and/or type of haptic transducer, sensor, and/or feedback mechanism. For example, haptic devices 2010, 2020, 2104, and 2230 may include one or more mechanical transducers, piezoelectric transducers, and/or fluidic transducers. Haptic devices 2010, 2020, 2104, and 2230 may also include various combinations of different types and forms of transducers that work together or independently to enhance a user's artificial-reality experience. In one example, each of band elements 2232 of haptic device 2230 may include a vibrotactor (e.g., a vibrotactile actuator) configured to vibrate in unison or independently to provide one or more of various types of haptic sensations to a user.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A device comprising at least one of:
(a) a computing device comprising:
a physical processor;
a power management circuit;
a multi-purpose connector comprising at least one of at least one data terminal or at least one power terminal;
a detector configured to detect when the multi-purpose connector has connected to at least one of a power source or a smart accessory; and
a switch that at least one of:
connects at least one of the at least one power terminal or the at least one data terminal to the power management circuit in response to the detector detecting that the multi-purpose connector has connected to the power source; or
connects the data terminal to the physical processor in response to the detector detecting that the multi-purpose connector has connected to the smart accessory;
(b) a microfluidic device, comprising:
a stator substrate including electrodes and at least one stator fluid passageway through the stator substrate; and
a rotor adjacent to the stator substrate and rotatable relative to the stator substrate, the rotor including:
an electromagnetically sensitive material configured to receive a rotational force from the electrodes of the stator substrate upon actuation of the electrodes; and
at least one rotor fluid passageway through the rotor,
wherein the at least one rotor fluid passageway is positioned to be selectively aligned and misaligned with the at least one stator fluid passageway depending on a rotational position of the rotor;
(c) a microfluidic device, comprising:
an acoustic standing wave generator, comprising:
an acoustic diaphragm; and
an acoustic cavity within which a standing wave is generated by the acoustic diaphragm;
a microfluidic valve adjacent to the acoustic standing wave generator, the microfluidic valve comprising:
a stator substrate including electrodes and at least one stator fluid passageway through the stator substrate;
a rotor adjacent to the stator substrate and rotatable relative to the stator substrate, the rotor including:
an electromagnetically sensitive material configured to receive a rotational force from the electrodes of the stator substrate upon actuation of the electrodes; and
at least one rotor fluid passageway through the rotor,
wherein the at least one rotor fluid passageway is positioned to be selectively aligned with the at least one stator fluid passageway at times that are synchronized with the standing wave generated by the acoustic standing wave generator;
(d) a mating system comprising:
one or more barbed connectors coupled to a first circuit board and configured to hold the first circuit board in a mated position with a second circuit board,
wherein the one or more barbed connectors are at least one of:
an integral part of a plastic housing of the first circuit board; or
permanently affixed to the plastic housing of the first circuit board;
(e) an electronics routing system comprising:
a wire embedded into an inner layer of a substrate, said wire being embedded at least one of:
by an embedded die lamination process; or
between a sandwiched pair of printed circuit boards having the wire hot bar soldered to at least one of the printed circuit boards; or
(f) a wire-to-board interconnect, comprising:
two or more rows of micro-coaxial wire (MCX) attached to a printed circuit board assembly having a board-to-board connector on a side thereof opposite the two or more rows of MCX, wherein the two or more rows of MCX are stacked in a manner that allows separation of ground on a first set of MCX shields of a first row of the two or more rows of MCX and power on a second set of MCX shields of a second row of the two or more rows of MCX;
a first ground bar configured to tie together the first set of MCX shields; and
a second ground bar that is separate from the first ground bar and is configured to tie together the second set of MCX shields.
